(19) United States
(12) Patent Application Publication
(10) Pub. No.: US 2024/0414236 A1
(43) Pub. Date: Dec. 12, 2024

(54) SYSTEM ENABLING REMOTE CONTROL OF A USER OPERABLE DEVICE VIA A SOCIAL MEDIA PLATFORM, AND METHOD AND NON-TRANSITORY COMPUTER READABLE MEDIUM

(71) Applicant: HYTTO PTE. LTD, Singapore (SG)

(72) Inventors: Dan LIU, Guangzhou (CN); Jilin QIU, Guangzhou (CN)

(73) Assignee: HYTTO PTE. LTD, Singapore (SG)

(21) Appl. No.: 18/208,151

(22) Filed: Jun. 9, 2023

(51) Int. Cl. H04L 67/125; A61H 19/00; G06F 3/04842

(52) U.S. Cl. CPC H04L 67/125; A61H 19/00; A63F 13/795; G06F 3/011; G06F 3/016; G06F 3/04842; G06Q 50/01; A61H 2201/5012

(57) ABSTRACT

A system for facilitating interaction between users of an online social media platform, and control of accessories operated by the users. Each user of the platform has a profile page that they configure and that is selectively viewable to other users. The system provides a first user of the platform with the ability to remotely control an accessory operated by a second user of the platform, while viewing the second user's profile page. An interface for enabling the remote control may be provided within the platform page. In addition, control of an accessory operated by the first user, the second user, or both, can be performed based on predetermined control information associated with the second user.

### FIELD

The present invention relates to an online system and application (e.g., social media platform and/or application) enabling interaction between at least first and second users, where at least one of the first and second users operates a remotely operable interactive adult toy.

### BACKGROUND

Online platforms which enable connection between users located at physically disparate locations are known. In such a system, users can view online profiles created by other users, and can determine whether and how they wish to interact with the other users.

For example, USP 9, 733, 811 describes a known online dating/matchmaking system that allows users to search for other users who share similar character traits, values, interests, etc., and that provides ways for users who have shown mutual interest in communicating with each other to interact with each other.

In addition, recently, social media, online broadcasting, and the ability to extend hardware interfaces via local and wide area networking have contributed to the configurability of adult toys. These technologies provide new ways to enable individuals to experience sexual stimulation without direct physical contact between them.

### SUMMARY

According to an embodiment, a system, method, and non-transitory computer-readable recording medium provide an online platform over which users can communicate, interact, and remotely control devices operated by other users.

In an embodiment, the system is provided via an online platform (e.g., a social media platform and/or application), in association with an interactive adult toy operable by users of the online platform. An embodiment described herein makes it possible to enable types of interaction that were not previously possible between users of an online social media platform and/or application.

Additional features and advantages of the invention will become apparent from the following detailed description and appended claims.

### BRIEF DESCRIPTION OF THE DRAWINGS

In the following detailed description reference is made to the accompanying drawings, in which:

FIG. 1 is a block diagram illustrating an overall configuration of a system according to an embodiment;

FIG. 2 is a block diagram illustrating a hardware configuration of a user-operable terminal provided in the system;

FIG. 3 is a block diagram illustrating a hardware configuration of a server provided in the system;

FIG. 4 schematically illustrates contents of a session screen provided to a user of the terminal;

FIGS. 5A and 5B illustrate examples of the session screen of FIG. 4;

FIG. 6 schematically illustrates contents of another session screen provided to a user of the terminal;

FIGS. 7A-7D illustrate examples of the session screen of FIG. 6;

FIG. 8 is a flow chart illustrating a flow of control processing carried out in the system; and

FIG. 9 is a flow chart illustrating another flow of control processing carried out in the system.

### DETAILED DESCRIPTION

Hereinafter, embodiments of the present invention are described with reference to the drawings, in which same reference numerals are given to same or corresponding portions, and redundant explanation thereof is omitted. It is noted that the drawings are only schematic diagrams for the present embodiment to be sufficiently understood.

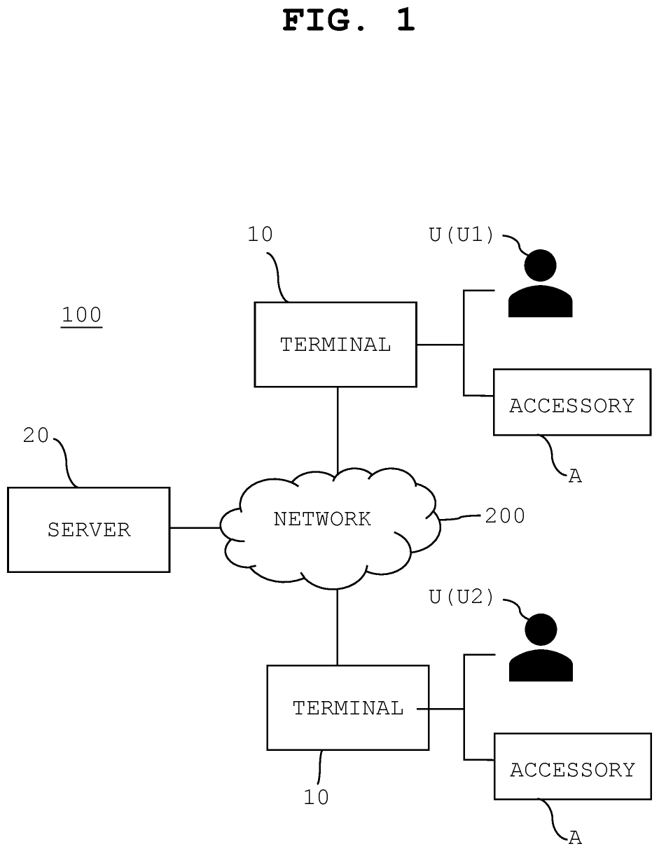

FIG. 1 is a block diagram schematically showing an exemplary configuration of a system 100 according to an embodiment. The system 100 includes terminals 10 and a server 20, wherein the terminals 10 and the server 20 are connected via a network 200 (e.g., the Internet). Each of the terminals 10 is operable by a respective one of users U (e.g., a first user U1 and a second user U2). While FIG. 1 illustrates two users U for the sake of convenience, the number of users U is not intended to be limited.

According to an embodiment, the system 100 provides a social media platform via a website, and/or via an application installed on one or more of the terminals 10. In addition, an accessory A is provided to each of the users U, and is operable by its respective user U. The accessory A is communicably connectable to its respective terminal 10, for example, by wired or short range wireless communication. An example of the accessory A is an interactive adult toy which is operable by a user U (e.g., a user U1) to achieve sexual stimulation, and the operating parameters of the adult toy are remotely controllable (e.g., by another user U2) in response to control instructions transmitted thereto via the wired or short range wireless communication. While the present disclosure discusses an adult toy as an example of the accessory A, it is recognized that various different accessories A operable by users U of the respective terminals 10, and communicably couplable to the user's respective terminals 10, can be controlled in a similar way. Further, while FIG. 1 illustrates each user U having their own accessory A, it is possible for only some (or at least one) of the users U of the system 100 to operate an accessory A.

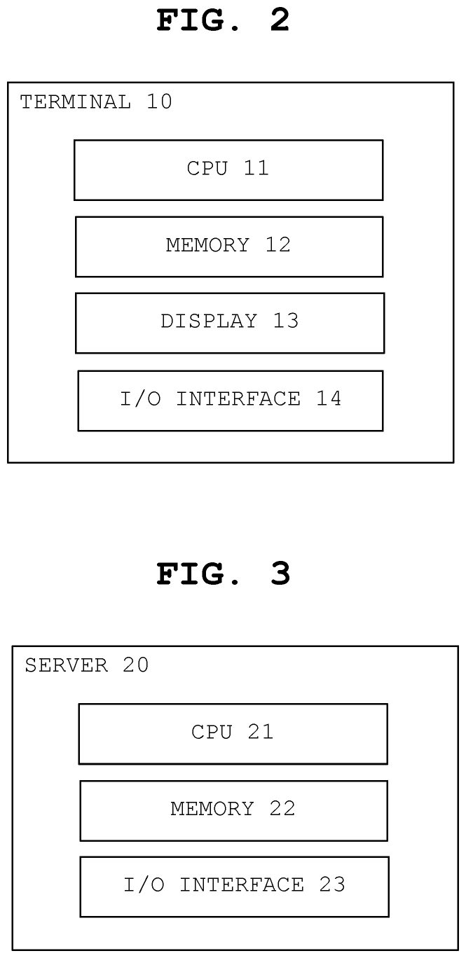

FIG. 2 is a block diagram illustrating an exemplary configuration of the terminal 10. The terminal 10 may include a hardware processor (CPU) 11, a memory 12, a display 13, and an input/output (IO) interface 14. For example, the terminal 10 may be configured as one of a computer (e.g., a desktop or laptop computer), a mobile device (e.g., smartphone or tablet), a video game console, and the like.

FIG. 3 is a block diagram showing an exemplary configuration of the server 20. As shown in FIG. 3, the server 20 includes a hardware processor (CPU) 21, a memory 22, and an input/output (IO) interface 23. The CPU 21 is configured to execute various processes, discussed in further detail below, under control of a program stored in the memory 22.

While FIGS. 2 and 3 illustrate a configuration in which a hardware processor (CPU) operates under control of a program stored in a memory, an alternate embodiment is also envisaged whereby the hardware processor is configured as a standalone processing circuit. In addition, or alternatively, the various components of the terminal 10 can be combined as one or more integrated processing circuits as appropriate. The specific circuit configuration is not intended to be limited, and any circuit capable of carrying out the described functions of the hardware processor (CPU) operating under control of the stored program are considered within the scope of this disclosure.

The accessory A may be provided with variable intensity settings (e.g., different intensity levels of output, such as vibration levels, rotation speeds, expansion sizes, lighting, sound output, and the like), which are controllable by control instructions received from a user U operating the accessory A, or control instructions received by another user U of the online social media platform, via the terminal 10 with which the accessory A is in wired or wireless communication.

According to an embodiment, the server 20 provides an online social media platform and/or application to the terminals 10 in response to a request. The server 20 may be configured as a web server providing the online social media platform as a website accessible by the terminals 10. In addition, the terminals 10 may have an application installed locally which can communicate with the server 20 and on which the user U thereof can browse the online social media platform. These examples are not intended to be limited, and it is understood that the functionality of the online social media platform described herein can be implemented by various specific hosting configurations. The provision of the online social media platform to the terminals 10 enables the users U to interact with each other, and to interact with accessories A operated by themselves and other users, either directly or indirectly, via various user interfaces provided by the online social media platform, as discussed in further detail below.

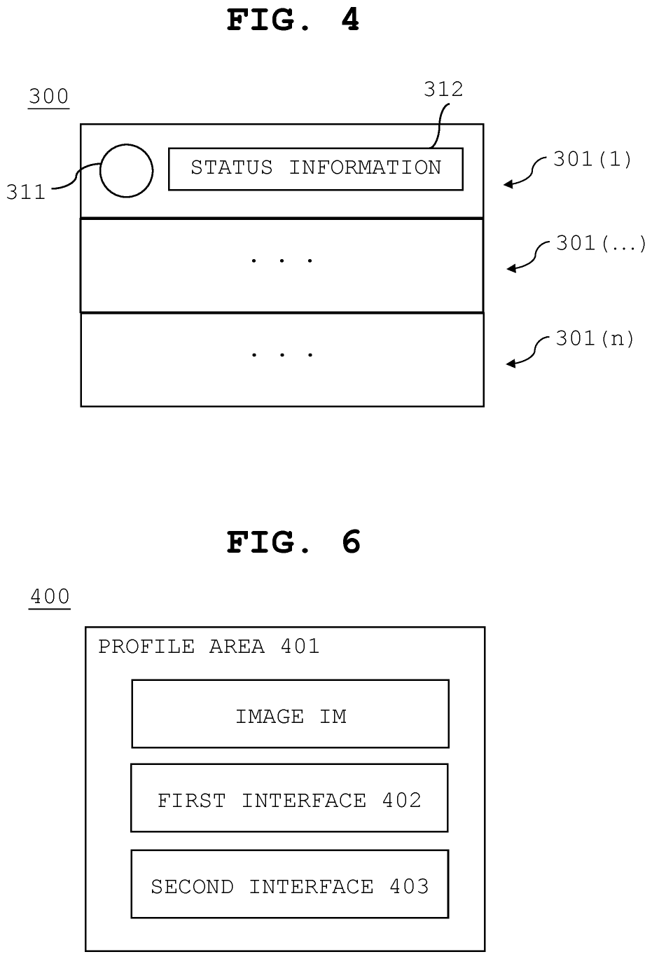

FIG. 4 schematically illustrates a session screen 300 provided to a first user U1 at a respective one of terminals 10 operated by the user U1 (e.g., on the display 13 thereof) while the user U is browsing the online social media platform provided thereto. In a similar way, the session screen 300 may also be provided to a respective one of terminals 10 operated by the user U2. In the example of FIG. 4, the session screen 300 includes display of at least one of a plurality of selectable items 301. Each of the selectable items 301 corresponds to a profile page of a respective one of the users U. For example, each selectable item 301 may include a profile picture 311 of the user U to which the profile belongs, as well as status information 312. The status information 312 may include information regarding an active state of the user U (e.g., whether the user U is busy, currently online, and/or available to connect), and may also include user accessory information regarding the accessory A operated by the user U (e.g., whether the accessory A is currently being operated or idle).

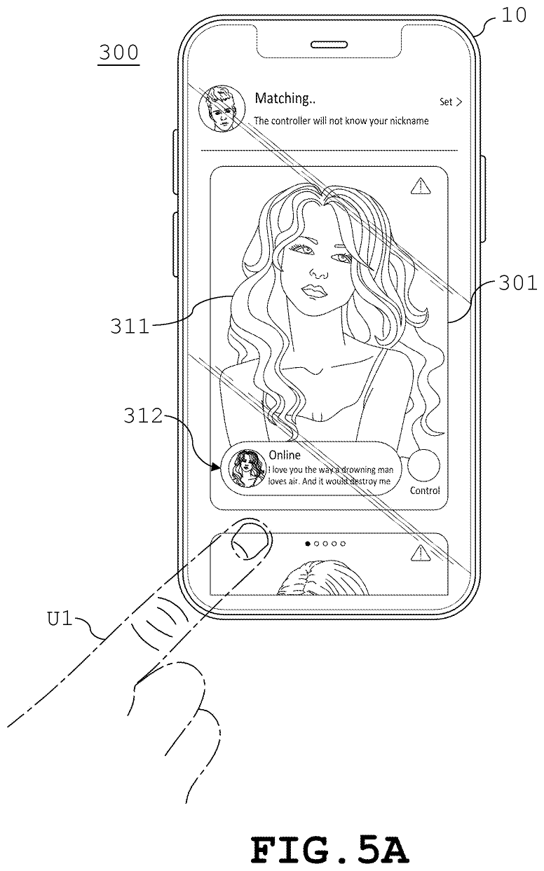

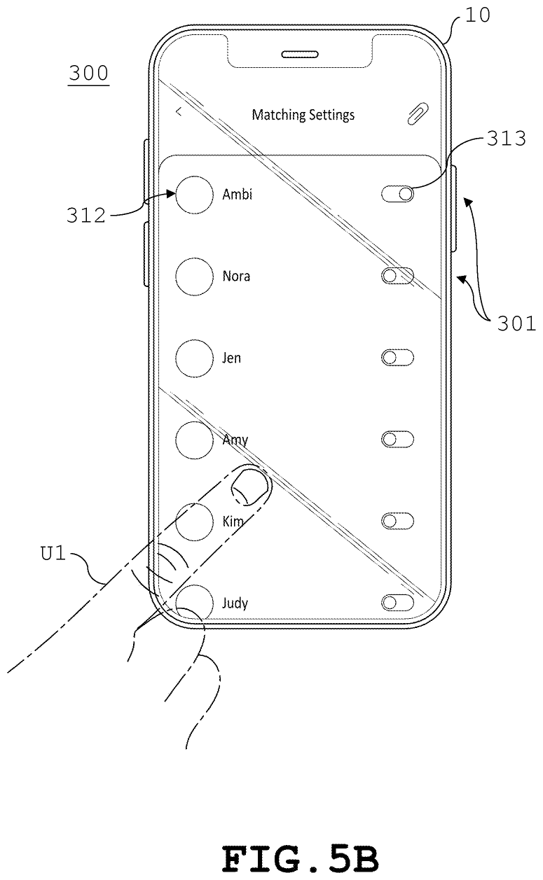

FIG. 5A illustrates an exemplary session screen 300 in which one of the selectable items 301 is displayed at a time, and the first user U1 can switch among the selectable items 301 by an input operation (e.g., a swiping operation). That is, the first user U1 can “swipe” among the plurality of selectable items 301 one at a time, until finding another user U they are interested in connecting with. In an embodiment, the session screen 300 may also display a portion of a selectable item 301 adjacent to the one currently displayed, to indicate to the first user U1 that an additional selectable item(s) 301 beyond the one currently displayed is/are available for selection.

FIG. 5B illustrates another exemplary session screen 300 in which a plurality of the selectable items 301 are displayed in list form, with each selectable item 301 being displayed in association with its respective status information 312. In the example of FIG. 5B, when the number of selectable items 301 is greater than a number of selectable items 301 displayable on the display 13 at once, the first user U1 can perform an input operation to “scroll” among the list of selectable items 301 to change which of the plurality of selectable items 301 are currently being displayed. As shown in the exemplary session screen 300 of FIG. 5B, a selector 313 may be displayed in association with each selectable item 301 as an interface element (e.g., a toggle icon) operable by the user U1 to select the selectable item 301 with which it is associated. The selector 313 is not intended to be limited to a toggle icon, and other interface elements enabling selection are also envisaged. The exemplary session screen 300 of FIG. 5B may alternately be configured such that the selectable item 301 is directly selectable by the first user U1 (e.g., by a “tap” operation).

The examples of FIGS. 5A and 5B are not intended to be limited only to the user input operations discussed above, and the session screen 300 can be configured to include one or more additional interface element(s) to facilitate selection of one or more of the plurality of selectable items 301, regardless of whether they are displayed one at a time or in list form.

The system 100 may be configured such that the selectable items 301 displayed in the session screen 300 are selected based on predetermined criteria. For example, the session screen 300 may display only selectable items 301 which correspond to users U having a predetermined status. The predetermined status may be, for example, a status whereby the user U is online and whereby an accessory A associated with the user U is connected, in an operable state, and idle. In addition, or alternatively, the session screen 300 may display selectable items 301 of users U selected by matching based on predetermined rules defined by the first user U1. For example, the predetermined rules may include rules pertaining to geographical location, values, sexual orientation, and accessory compatibility of users U.

FIG. 6 schematically illustrates an exemplary session screen 400 provided to the first user U1 after receiving a selection operation by the first user U1 of one of the displayed list of selective items 301.

Here, the selection operation is an operation by the first user U1 to select a second user U2 from among users U respectively associated with the displayed selection items 301. For example, the selection operation may include a direct selection by the first user U1, whereby the first user directly selects the second user U2 by selecting a corresponding one of the selection items 301 by a swiping operation, a click, a double click, and the like. However, the selection operation may also be an indirect input operation. For example, when a display effect of a currently displayed user profile page meets a predetermined condition (e.g., more than half of the page is shown during a swiping operation by the first user), that user profile page can be considered “selected.” In addition, when the first user U1 views a specific user's profile page for more than a predetermined amount of time (e.g., five seconds) while “swiping” among plural user profile pages, the specific user's profile page can be considered “selected.” The above selection operations are not intended to be limited, and can be combined as appropriate, and it is to be appreciated that various different direct or indirect inputs by the first user U1 can be used as a basis for the selection operation. Further, the selection operation by the first user U1 may not be processed until connection is approved by the second user U2 with whom the first user U1 wishes to connect.

A “profile page” as referred to herein is a page unique to one user U of the online social media platform and which is configured by the one user U to include information visible to other users U. The profile page may include at least one piece of information regarding the specific user U, where the at least one piece of information is definable by the specific user U. The at least one piece of information may include the profile picture 311, personal introduction information, signature information, and/or user accessory information. Each of the personal introduction information and the signature information may include at least one of text information, voice information, and video information. These types of information are not intended to be limited, and may be freely defined by the user U as desired.

Further, the user accessory information, which is definable by, specific to, and stored in association with a respective one of the users U, may include model information (e.g., model information of the user's accessory A and/or operational capabilities of the accessory A), control mode information (e.g., modes under which the accessory A is controllable), and/or controllable features of the accessory A operated by the user U. The user accessory information may further include specific predetermined control instructions, defined by the user U, for automatic control of functions and/or parameters of the user's accessory A. As discussed above with respect to FIG. 4, the user accessory information may be displayed as a component of the status information 312.

As shown in FIG. 6, the session screen 400 may include an profile area 401 in which the profile page of the selected second user U2 is displayed. The profile area 401 may include a live view or still image IM of the selected second user U2, and a first interface 402 may be displayed in association with the profile area 401 (e.g., by being superimposed over the profile area 401, and/or displayed adjacent to the profile area 401).

The first interface 402 is an interface which enables direct control of parameters of the accessory A operated by the second user U2 selected by the selection operation received from the first user U1. In an embodiment, after the first user U1 selects the profile of the second user U2 by the selection operation, the first user U1 may be granted direct control of the parameters of the accessory A operated by the second user U2 via the interface 402 without requiring further authorization or consent by the second user U2. In another embodiment, control of the accessory A operated by the second user U2 may not be given to the first user U1 unless authorized by the second user U2.

In an embodiment, the first interface 402 comprises a touch panel area within which the first user U1 can input touch operations which in turn control respective controllable parameters of the accessory A operated by the second user U2. The touch operations may include, but are not limited to, tap and swipe operations. The first interface 402 may alternately (or additionally) include selectable interface elements (e.g., buttons) which can be used to control the respective parameters. While specific examples have been provided, it is envisioned that the first interface 402 can be configured in various different formats to realize the above-described purpose of control of the accessory parameters.

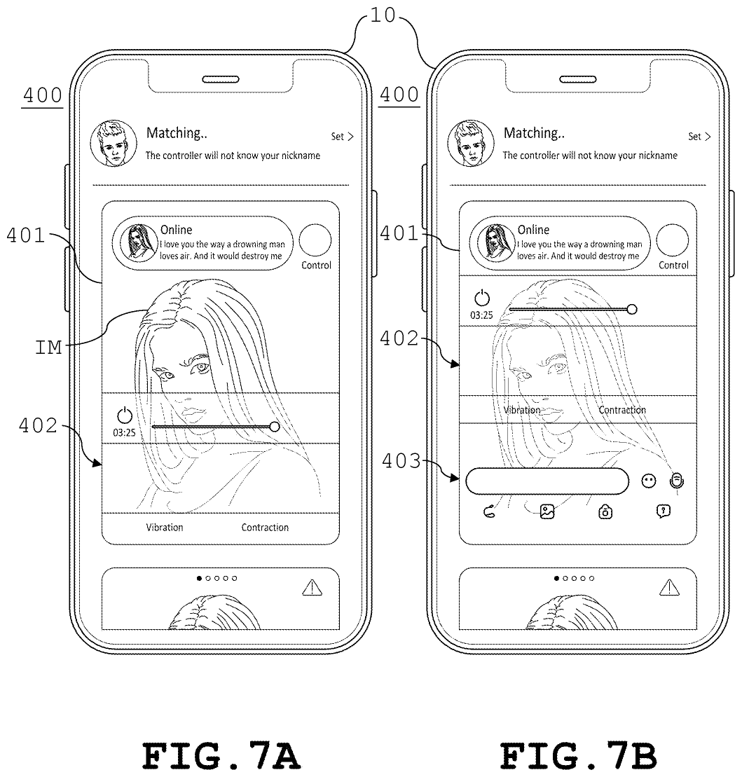

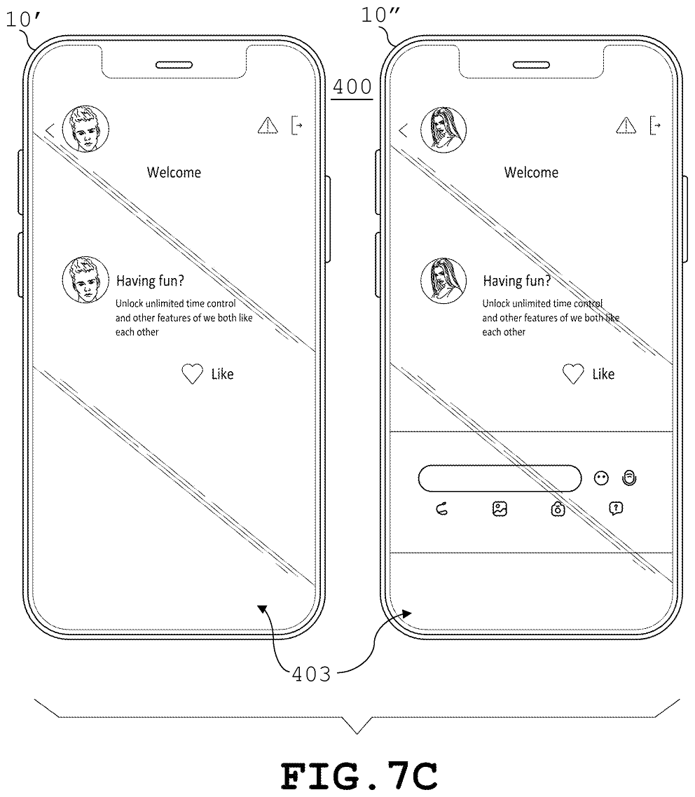

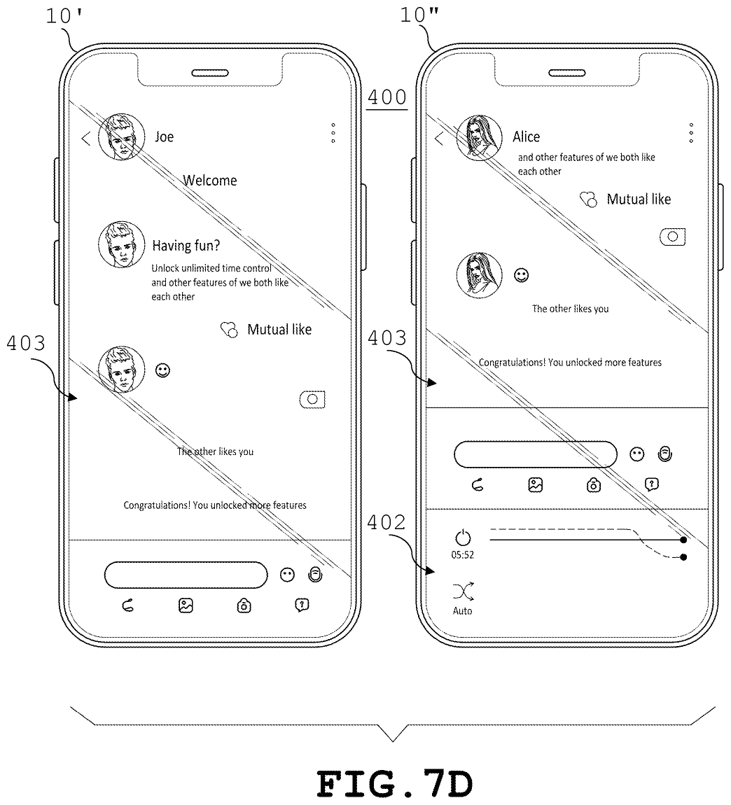

FIG. 7A illustrates an exemplary session screen 400 in which the first interface 402 is displayed so as to be superimposed over the profile area 401. In this case, the first interface 402 may be made partially transparent such that the profile area 401 is visible therethrough. In an alternate embodiment, the first interface 402 may be made opaque.

In an embodiment, the first interface 402 is provided to the first user U1 to enable control of the accessory A of the second user U2 at any point during a period of time during which the first user U1 is viewing the profile page of the selected second user U2. It is also envisaged that information regarding the control performed via the first interface 402 may be displayed at the terminal 10 operated by the second user U2. In a modification, control of the accessory A by the first user U1 via the first interface 402 may be provided only during a period of time during which the first user U1 and the second user U2 are simultaneously viewing each other's profiles.

As shown in FIG. 6, the session screen 400 may include a second interface 403 provided instead of, or in addition to, the above-described first interface 402. FIG. 7B shows an exemplary session screen 400 having a configuration whereby both the first interface 402 and the second interface 403 are shown. As with the first interface 402, the second interface 403 may be displayed in association with the profile area 401. In the example of FIG. 7B, the first interface 402 and the second interface 403 are superimposed over the profile area 401.

The second interface 403 is configured to enable the first user U1 to interact with the selected second user U2 in various ways different from the above-described control of the accessory A. For example, the second interface 403 may enable the first user U1 to “flag” the second user U2 as a person of interest, to chat with the second user U2 (e.g., by text, video, and/or voice), to switch a currently displayed profile page to a page of a different user U, initiating a friend request to the second user U2, sending a greeting to the second user U2, etc.

FIG. 7C illustrates an exemplary session screen 400 in which the second interface 403 is displayed on terminals 10′ and 10″ operated by the first user U1 and the second user U2, respectively. In the example of FIG. 7C, each of the first user U1 and the second user U2 has the ability to communicate with the other (e.g., by voice or text chat), as well as to “flag” the other as a person of interest (e.g., by “liking” the user U with which they are connected). These examples are not intended to be limiting, and various types of interactions between the first user U1 and second user U2 can be facilitated by the second interface 403.

As noted above, the second interface 403 provides the ability for the first user U1 and the second user U2 to “flag” the other as a person of interest. In an embodiment, in a case in which each of the first user U1 and the second user U2 has flagged the other as a person of interest, additional functions and/or features of the accessory A may be made available to the first user U1 in the first interface 402. For example, portions of the first interface 402 which were previously not controllable by the first user U1 may be made controllable, and/or new features and/or parameters of the accessory A which were not previously made accessible to the first user U1 can be made accessible for control. FIG. 7D illustrates exemplary session screens 400 provided to the terminals 10′ and 10″ respectively operated by the first user U1 and the second user U2, in which each of the first user U1 and the second user U2 has “liked” the other, thereby making new features available to the first user U1 and/or the second user U2.

In this connection, the system 100 may also be configured to provide a punishment mechanism by which, after the first user U1 and the second user U2 have “liked” each other in the manner described above, but the first user U1 repeatedly terminates/re-initiates the connection with the second user U2, and/or fails to make sufficient use of the new features made available by the first user U1 and the second user U2 having “liked” each other (e.g., by not controlling the accessory A in a timely manner, or in a manner satisfactory to the second user U2), the first user U1 may be subjected to a punishment. For example, the punishment may include disabling the ability of the first user U1 to perform matching with the second user U2 (or any other user U of the system 100) for a certain period of time, disabling the ability of the first user U1 to perform remote control of the accessory A for a certain period of time, and the like. The punishment may be set by the first user U1 and/or the second user U2.

In the embodiment discussed above, the first user U1 selects a second user U2 by the selection operation; however, the present invention is not limited to this. For example, the system 100 may be configured such that the first user U1 may input a plurality of selection operations to the session screen 300 to select a plurality of second users U2.

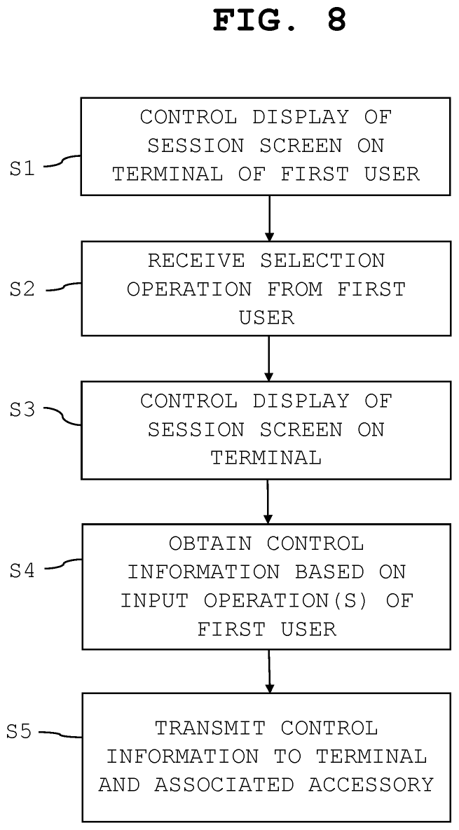

An example of operation of the system 100 will now be discussed with reference to FIG. 8. FIG. 8 illustrates a flow chart of processing executed under control of the CPU 21 of the server 20. In an embodiment, the CPU 21 executes the processing described below under control of a program stored in the memory 22.

As illustrated in FIG. 8, in step S1, the server 20 controls display of the session screen 300 at a terminal 10 operated by the first user U1.

In step S2, the server 20 receives a selection operation from the first user U1 selecting one of the selectable items 301 displayed in the session screen 300, thereby selecting a second user U2 corresponding to the selected selectable item 301.

In step S3, in response to the selection operation, the server 20 controls display of the session screen 400 at the terminal 10 operated by the first user U1. Here, the control of the display of the session screen 400 includes control of the above-described first and second interfaces 402, 403, as appropriate.

In step S4, the server 20 obtains, from the terminal 10 operated by the first user U1, control information based on input operations performed by the first user U1 to the displayed session screen 400.

In step S5, the server 20 transmits the obtained control information to the terminal 10 operated by the second user U2, which in turn performs control as appropriate in accordance with the received control information. For example, the control information may be used to perform control of the accessory A of the second user U2, in the manner discussed above.

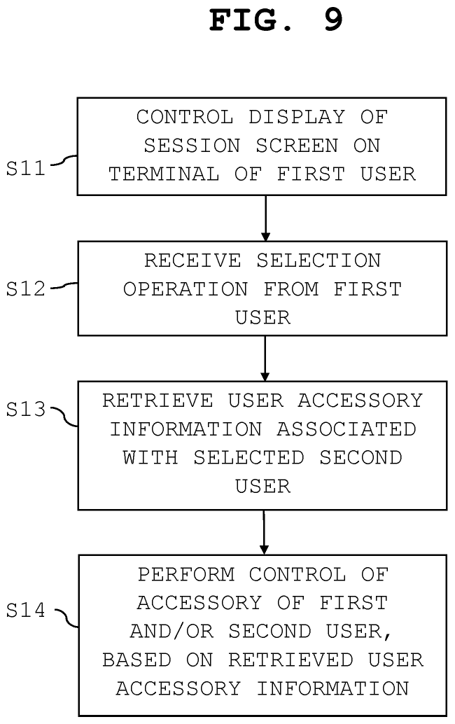

FIG. 9 illustrates a flow chart of another exemplary processing executed under control of the CPU 21 of the server 20, under control of a program stored in the memory 22.

As illustrated in FIG. 9, in step S11, the server 20 controls display of the session screen 300 at a terminal 10 operated by the first user U1.

In step S12, the server 20 receives a selection operation from the first user U1 selecting one of the selectable items 301 displayed in the session screen 300, thereby selecting a second user U2 corresponding to the selected selectable item 301.

In step S13, in response to the selection operation, the server 20 retrieves the user accessory information (described above) associated with the second user U2. For example, the user accessory information may be retrieved from the memory 22 and/or may be directly retrieved from the terminal 10 operated by the second user U2.

In step S14, control is performed in accordance with the retrieved user accessory information (which, as discussed in detail above, is associated with and defined by the second user U2). For example, automated control of an accessory A operated by the first user U1 may be performed based on the control information contained in the user accessory information. In addition, or alternatively, automated control of an accessory A operated by the second user U2 may be performed based on the control information.

While the features of FIGS. 8 and 9 have been described as being performed under control of the server 20, an alternate embodiment is envisioned whereby the terminals 10 operated by the respective first and second users U1, U2 execute this control either singly or in combination.

The system, method, and non-transitory computer-readable recording medium according to an embodiment described above achieves an improvement over conventional technology by extending hardware capabilities of an accessory (e.g., adult toy) operated by users U of an online social media platform and/or application, enabling the users to interact with and/or control operation/manipulation of each other's accessories via interfaces provided directly within the online social media platform itself, thereby realizing new ways of interaction and improved mutual enjoyment between the users U of the online social media platform and/or application.

It will be apparent to those skilled in the art that various modifications and variations can be made to the system and method described herein. It should be understood that the drawings and detailed description thereto are not intended to limit the invention to the particular form disclosed, and that additional embodiments will be apparent to those skilled in the art from consideration and/or practice of the instant disclosure. It is intended that the specification, drawings, and examples provided herein be considered as exemplary, with that the true scope of the invention, including modifications, equivalents, and alternatives falling within the spirit and scope thereof, being described by the appended claims.

1. A system providing an online platform to facilitate interaction between plural users of the platform, the system comprising:
a software application executed on a first terminal operable by a first user from among the plural users of the platform;
a memory; and
a hardware processor configured to, under control of a program stored in the memory, execute processes comprising:
maintaining status information for at least one second user from among the plural users of the platform, the status information including information on (i) an active state of the second user and (ii) accessory information for the second user, the information on the active state of the second user comprising information indicating whether the second user is at least one of busy and currently online, and the information on the accessory information for the second user comprising information indicating whether an adult toy operated by the second user is at least one of in a connected state, in a remotely operable state, and idle;
controlling to display, on the first terminal, at least one of a plurality of first selectable items, each of the first selectable items corresponding to a respective user from among a subset of the plural users and including the status information pertaining to the respective user;
receiving, from the first user, a selection operation selecting one of the first selectable items, the selected one of the first selectable items corresponding to the second user from among the plural users;
in response to the selection operation and the status information of the second user matching a predetermined status whereby the second user is online and the adult toy operated by the second user is connected, in the remotely operable state, and idle, providing, on the first terminal, an interface by which the first user can directly remotely control the adult toy operated by the second user; and
generating a control instruction based on input by the first user via the interface, and outputting the control instruction to the adult toy, the control instruction comprising instructions which remotely control the adult toy to perform a predetermined operation, and the adult toy being communicably coupled with a second terminal operated by the second user.

2-4. (canceled)

5. The system according to claim 1, wherein the interface comprises an interface by which the first user can directly remotely control parameters of the adult toy operated by the second user.

6. The system according to claim 5, wherein remote control of the adult toy via the interface by the first user is enabled during a period of time during which the first user is viewing a profile of the second user.

7. The system according to claim 5, wherein the interface comprises an interface for the first user to flag the second user as a user of interest.

8. The system according to claim 7, wherein in a case in which both the first user and the second user flag each other as a user of interest, additional controllable functions of the adult toy not previously made available in the interface are made available to at least one of the first user and the second user.

9. The system according to claim 1, wherein the interface comprises an interface enabling the first user and the second user to communicate with each other by at least one of text, video, and voice.

10. The system according to claim 9, wherein the interface comprises interface components enabling operations including (i) switching a currently displayed user profile, (ii) initiating a friend request to the second user, and (iii) sending a greeting to the second user.

11. The system according to claim 1, wherein the hardware processor is configured to:
display a list including at least a portion of the plurality of first selectable items; and
display plural user profiles in response to selection by the first user of a plurality of the first selectable items displayed in the list.

12. (canceled)

13. The system according to claim 1, wherein the hardware processor is further configured to select the subset of plural users by matching based on predetermined rules, the predetermined rules being definable by the first user and including rules pertaining to geographical location, values, sexual orientation, and accessory compatibility.

14. The system according to claim 1, wherein the interface comprises at least one piece of information regarding the second user, the at least one piece of information being definable by the second user.

15. The system according to claim 14, wherein the at least one piece of information comprises at least one of personal introduction information, signature information, and user accessory information.

16. The system according to claim 15, wherein each of the personal introduction information and the signature information comprises at least one of text information, voice information, and video information, and the user accessory information comprises at least control mode information indicating controllable features of the accessory operated by the second user.

17. A system providing an online platform to facilitate interaction between plural users of the platform, the system comprising:
a memory; and
a hardware processor configured to, under control of a program stored in the memory, execute processes comprising:
maintaining status information for at least one second user from among the plural users of the platform, the status information including information on (i) an active state of the second user and (ii) accessory information for the second user, the information on the active state of the second user comprising information indicating whether the second user is at least one of busy and currently online, and the information on the accessory information for the second user comprising information indicating whether an adult toy operated by the second user is at least one of in a connected state, in a remotely operable state, and idle;
controlling to display, on a first terminal operated by a first user from among the plural users, at least one of a plurality of first selectable items, each of the first selectable items corresponding to a profile page of a respective user from among a subset of the plural users and including the status information pertaining to the respective user;
receiving, from the first user, a selection operation selecting one of the first selectable items, the selected one of the first selectable items corresponding to the second user from among the plural users; and
in response to the selection operation and the status information of the second user matching a predetermined status whereby the second user is online and the adult toy operated by the second user is connected, in the remotely operable state, and idle, controlling parameters of at least one remotely operable adult toy, each of the at least one adult toy being communicably connected with at least one of the first terminal operated by the first user and a second terminal operated by the second user, and each of the at least one adult toy being operated by a respective one of the first user and the second user,
wherein the controlling comprises controlling the parameters of each of the at least one adult toy based on predetermined control instructions associated with the second user.

18. The system according to claim 17, wherein each of the at least one adult toy is communicably connected with a respective one of the first terminal and the second terminal via which the adult toy is remotely operated.

19. The system according to claim 18, wherein the predetermined control instructions comprise at least one set of control instructions for controlling the parameters of each of the at least one adult toy.

20. A method in a system providing an online platform to facilitate interaction between plural users of the platform, the system including a memory and a hardware processor, the method being executed by the hardware processor, and the method comprising:
maintaining status information for at least one second user from among the plural users of the platform, the status information including information on (i) an active state of the second user and (ii) accessory information for the second user, the information on the active state of the second user comprising information indicating whether the second user is at least one of busy and currently online, and the information on the accessory information for the second user comprising information indicating whether an adult toy operated by the second user is at least one of in a connected state, in a remotely operable state, and idle;
controlling to display, on a first terminal operable by a first user from among the users of the platform, at least one of a plurality of first selectable items, each of the first selectable items corresponding to a respective user from among a subset of the plural users and including the status information pertaining to the respective user;
receiving, from the first user, a selection operation selecting one of the first selectable items, the selected one of the first selectable items corresponding to the second user from among the plural users;
in response to the selection operation and the status information of the second user matching a predetermined status whereby the second user is online and the adult toy operated by the second user is connected, in the remotely operable state, and idle, enabling, at the first terminal, a control function by which the first user can directly remotely control the adult toy operated by the second user; and
generating a control instruction based on input by the first user via the control function, and outputting the control instruction to the adult toy, the control instruction comprising instructions which remotely control the adult toy to perform a predetermined operation, and the adult toy being communicably coupled with a second terminal operated by the second user,
wherein the control function by which the first user can remotely control the adult toy operated by the second user is enabled at the first terminal during a period of time during which the first user is viewing a profile of the second user.

21. (canceled)

22. The system according to claim 1, wherein the first terminal and the second terminal are in a connectable state during a period of time during which the first user is viewing the first selectable items including a first selectable item corresponding to the second user.

23. (canceled)

24. The system according to claim 1, wherein the active state in which the respective user is available to connect is selectable between (i) a state in which the adult toy operated by the respective user is able to be directly remotely controlled by the first user without requiring authorization and (ii) a state in which the adult toy operated by the respective user cannot be directly remotely controlled by the first user unless authorized by the second user.

25. The system according to claim 6, wherein the hardware processor is configured to provide the interface by at least one of (i) superimposing the interface over the profile of the second user and (ii) displaying the interface adjacent to the profile of the second user.
